(19) United States
(12) Patent Application Publication
(10) Pub. No.: US 2013/0225786 A1
(43) Pub. Date: Aug. 29, 2013

(54) COPOLYAMIDES

(71) Applicants: Thierry Briffaud, Caorches Saint Nicolas (FR); Quentin Pineau, Evreux (FR); Emilie Goncalves, Lyon (FR); Jerome Robert Dupuy, Rillieux Le Pape (FR); Alain Jean-Jacques Rousseau, Saint Priest (FR)

(72) Inventors: Thierry Briffaud, Caorches Saint Nicolas (FR); Quentin Pineau, Evreux (FR); Emilie Goncalves, Lyon (FR); Jerome Robert Dupuy, Rillieux Le Pape (FR); Alain Jean-Jacques Rousseau, Saint Priest (FR)

(73) Assignees: INSTITUT NATIONAL DES SCIENCES APPLIQUEES DE LYON, VILLEURBANNE CEDEX (FR); ARKEMA FRANCE, COLOMBES (FR)

(21) Appl. No.: 13/820,326

(22) PCT Filed: Sep. 2, 2011
(86) PCT No.: PCT/FR2011/052011

§ 371 Date: May 15, 2013

(30) Foreign Application Priority Data
Sep. 6, 2010 (FR) 1057053
Sep. 6, 2010 (FR) 1057067

(51) Int. Cl. C08G 69/26

(52) U.S. Cl. CPC C08G 69/26
USPC 528/324; 528/335; 528/338

(57) ABSTRACT

The invention relates to a copolyamide comprising units resulting from the polycondensation reaction of the following precursors:
terephthalic acid (a),
an aliphatic diamine (b) comprising x carbon atoms, x being an integer between 6 and 22, and
an aminocarboxylic acid and/or a lactam (c) comprising a main chain and at least one linear or branched alkyl branching, the total number of carbon atoms of the aminocarboxylic acid and/or of the lactam (c) being between 12 and 36.

The invention also relates to the process for preparing said copolyamide and to a composition comprising such a copolyamide.

The present invention relates to semiaromatic copolyamides having, inter alia, a high melting point and very good thermomechanical and flexibility properties, and also to the preparation process thereof and a composition comprising same.

Semiaromatic copolyamides are polyamides comprising at least two different units, at least one of said units of which comprises an aromatic ring resulting from an aromatic precursor, which may especially be an aromatic diamine or an aromatic dicarboxylic acid.

Among these semiaromatic copolyamides, those comprising an X,T unit resulting from the polycondensation of an aliphatic diamine comprising x carbon atoms (and denoted by X) and of terephthalic acid (denoted by T) have been known for just over fifteen years for their high melting point, for their very good mechanical and chemical properties and for their feasibility via polycondensation in a pressurized reactor. By way of illustration, mention may especially be made of the copolyamides described in document EP 0 550 314.

To improve some of the properties of such copolyamides, in particular their flexibility, which is characterized by a measurement of the flexural or tensile modulus, their ductility, which is characterized by elongation at break measurements, and also their toughness, which is characterized by notched or unnotched impact strength measurements, document US 2006/0235190 proposes copolyamides which originate from the following precursors:
terephthalic acid,
at least one linear aliphatic diamine of formula H₂N-(CH₂)ₓ-NH₂, x being an integer between 4 and 18,
at least one dimerized fatty acid comprising up to 44 carbon atoms, and, if necessary,
other aromatic dicarboxylic acids, aliphatic dicarboxylic acids and lactams or aminocarboxylic acids.

Among the copolyamides described in this document US 2006/0235190, the copolyamides 6,T/6,l/6,36, 6,T/6,6/6,36 and 6,T/12/6,36 (denoted by 1 to 3) were exemplified and compared to the comparative copolyamides 6,T/6,l, 6,T/6,6 and 6,T/12 (denoted by comp.1 to comp.3).

These copolyamides 1 to 3 have in common, in addition to the 6,T unit that originates from the reaction of hexamethylenediamine and terephthalic acid, the 6,36 unit that itself originates from the reaction of hexamethylenediamine with a dimerized fatty acid comprising 36 carbon atoms and that is available under the trade name Pripol®1012.

With reference to Table 3 from document US 2006/0235190, it is observed that the introduction of this 6,36 unit makes it possible to obtain copolyamides (copolyamides 1 to 3) that have improved elongation, therefore ductility, and toughness properties with respect to the comparative copolyamides 1 to 3 obtained from the same precursors, but in the absence of the fatty acid dimer comprising 36 carbon atoms.

Taking these observations into consideration, it would therefore be tempting to increase the proportion of dimerized fatty acid relative to the proportions of the other precursors to obtain a copolyamide having a ductility and a toughness that are improved at the same time.

However, it was observed that when the proportion of dimerized fatty acid comprising 36 carbon atoms is increased relative to the proportions of the other precursors, the polycondensation reaction for obtaining the corresponding copolyamide becomes difficult, or even impossible. Indeed, the formation of white spots in the reaction mixture is observed with the naked eye. The presence of these white spots increases with the content of dimerized fatty acid until a multiphase mixture is obtained that no longer allows the expected copolyamide to be synthesized.

The choice of a precursor such as a dimerized fatty acid comprising 36 carbon atoms therefore limits the possibility of obtaining a copolyamide having a ductility and a toughness that are improved at the same time.

Moreover, and as mentioned in document US 2006/0235190, the dimerized fatty acids that are commercially available are compounds which are in the form of a mixture of several oligomer compounds, mainly dimers (obtained by reaction of 2 fatty acid molecules), which may be saturated or unsaturated, but also residual monomers and trimers (obtained by reaction of 3 fatty acid molecules). In document US 2006/0235190, the precursors of dimerized fatty acid type should comprise at most 3% by weight of trimers.

The purity of these mixtures of dimerized fatty acids is an essential criterion for obtaining copolyamides that have the desired properties. Indeed, in order to have the best reproducibility during the polycondensation reaction, it is necessary to use a dimerized fatty acid that is as pure as possible, that is to say comprising the fewest unsaturated compounds, monomers and trimers, since the presence of such compounds has in particular a direct impact on the properties and also on the colour and the thermal stability of the final copolyamide. It then actually becomes necessary to adapt the respective contents of the other precursor monomers in order to obtain the thermomechanical properties desired for the copolyamide. There is therefore a real problem of reproducibility of the polycondensation reaction for obtaining the expected copolyamide from the various precursors, when one of these precursors consists of a dimerized fatty acid.

To improve this reproducibility, and therefore the industrial feasibility of such flexible semiaromatic copolyamides, it is then necessary to choose a dimerized fatty acid of very high purity, which is not without an effect on the cost of obtaining the final copolyamide.

The objective of the present invention is therefore to overcome all of the aforementioned drawbacks and to propose a copolyamide that has a melting point greater than or equal to 200° C., advantageously between 240° C. and 330° C. (measured by DSC), mechanical properties that are comparable to those of the copolyamides from the prior art and especially the copolyamides described in the aforementioned documents EP 0 550 314 and US 2006/0235190, and also flexibility properties that are improved relative to those of the copolyamides described in document EP 0 550 314, the process for preparing such flexible semiaromatic copolyamides not being limited by the degree of purity and by the content of a precursor of dimerized fatty acid type as in document US 2006/0235190.

The present invention therefore relates to a copolyamide comprising the units resulting from the polycondensation reaction of the following precursors:
terephthalic acid (a),
an aliphatic diamine (b), which is preferably linear, comprising x carbon atoms, x being an integer between 6 and 22, and
an aminocarboxylic acid and/or a lactam (c).

According to the invention, this aminocarboxylic acid and/or this lactam (c) comprises a main chain and at least one alkyl branching, which may be linear or branched, the total number of carbon atoms of this aminocarboxylic acid and/or of this lactam (c) being between 12 and 36. Advantageously, the minimum number of carbon atoms of this aminocarboxylic acid and/or of this lactam (c) is strictly greater than 12.

The choice of an aminocarboxylic acid and/or of a lactam, and not of a dimerized fatty acid comprising 36 carbon atoms intended to react with the aliphatic diamine as in document US 2006/0235190, makes it possible to have a source of precursor which is reliable and not dependent on the degree of purity available commercially.

Secondarily, this choice may also make it possible to decrease the number of precursors needed for the formation of one of the units of the semiaromatic copolyamide.

Furthermore, the fact that this aminocarboxylic acid and/or lactam (c) has at least one alkyl branching allows for a better compatibility with the other precursors that are the terephthalic acid and the diamine. Indeed, it is observed that during the polycondensation reaction of these three precursors (a), (b) and (c), the diamine (b) being hexanediamine, no white spots are formed, irrespective of the proportion of this aminocarboxylic acid and/or lactam (c).

As indicated above, the aminocarboxylic acid and/or the lactam (c) is formed of a main chain and of at least one alkyl branching. The total number of carbon atoms of the precursor (c), which therefore corresponds to the sum of the number of carbon atoms of the main chain and the number of atoms of the branching(s), is between 12 and 36, advantageously between 15 and 30 and, preferably, between 18 and 24.

It is specified here that, unless otherwise indicated, the expression “between”, which has just been mentioned in the preceding paragraph and which will also be used in the continuation of the present description, should be understood as including the limits cited.

The main chain of the aminocarboxylic acid and/or of the lactam (c) advantageously comprises between 6 and 18 carbon atoms and, preferably, between 10 and 12 carbon atoms.

As examples, the main chain may be formed by an aminodecanoic acid, by an aminoundecanoic acid or else by an aminododecanoic acid.

The alkyl branching(s) of the aminocarboxylic acid and/or of the lactam (c) may be linear and correspond to the formula CₓH₂ₓ₊₁, with x being an integer greater than or equal to 1.

It (they) may also be branched.

It is also quite possible to envisage that the main chain of the precursor (c) comprises at least one linear alkyl branching and at least one alkyl branching, the latter itself being branched.

Advantageously, this (these) branching(s) comprise(s) at least 5 carbon atoms, advantageously at least 6 carbon atoms and, preferably, at least 7 carbon atoms.

As examples, the alkyl branching may be an n-pentyl, n-hexyl, n-heptyl, n-octyl, n-nonyl, n-decyl, n-undecyl, n-docecyl or else n-octadecyl chain.

It is specified that the alkyl branching(s) may be connected to the main chain, either at a carbon atom, or at the nitrogen atom.

Use may very advantageously be made, as precursor (c), of N-heptyl-11-aminoundecanoic acid, which will be denoted by 18, since it comprises 18 carbon atoms in total, including 11 in the main chain and 7 in the n-heptyl branching. Other advantageous precursors (c) are N-heptyl-12-aminododecanoic acid (denoted by 19), N-dodecyl-11-aminoundecanoic acid (denoted by 23), N-dodecyl-12-aminododecanoic acid (denoted by 24), N-octadecyl-11-aminoundecanoic acid (denoted by 29) and N-octadecyl-12-aminododecanoic acid (denoted by 30).

It is specified that, in the present description, the abbreviations 18, 19, 23, 24, 29 and 30 used in the copolyamides explicitly cited correspond to the unit resulting from the precursor (c) and, by no means, to that which could result from the precursor (d).

The aliphatic diamine (b) itself comprises x carbon atoms, x being an integer between 6 and 22. It may be linear or branched.

When the aliphatic diamine (b) is branched, it is formed of a main chain and of at least one alkyl branching, it being possible for this alkyl branching itself to be linear or branched.

Preferably, the diamine (b) is aliphatic and linear. It may thus be especially chosen from hexanediamine (which is also known as hexamethylenediamine), heptanediamine, octanediamine, nonanediamine, decanediamine, undecanediamine, dodecanediamine, tridecanediamine, tetradecanediamine, hexadecanediamine, octadecanediamine, octadecenediamine, eicosanediamine and docosanediamine. Such diamines all have the advantage of being able to be biobased and to comprise organic carbon resulting from biomass, which could be determined according to the ASTM D6866 standard.

Preferably, the aliphatic diamine (b) is hexamethylenediamine (or hexanediamine) or decanediamine.

According to a first version of the invention, the polycondensation reaction can only be carried out with the precursors (a), (b) and (c) mentioned above. A copolyamide is then obtained which only consists of two different units, the X,T unit and the unit resulting from the precursor (c).

Such a copolyamide may comprise:
between 35 and 85 mol %, advantageously between 45 and 80 mol %, preferably between 50 and 75 mol % of terephthalic acid (a),
between 15 and 65 mol %, advantageously between 20 and 55 mol %, preferably between 25 and 50 mol % of aminocarboxylic acid and/or of lactam (c), and
between 35 and 85 mol %, advantageously between 45 and 80 mol %, preferably between 50 and 75 mol % of aliphatic diamine (b). In other words, the molar content of precursor (b) is equal to the molar content of precursor (a).

Among these copolyamides that consist only of two different units, mention will very particularly be made of:
the copolyamide 18/6,T, resulting from the polycondensation reaction of terephthalic acid, hexamethylenediamine and N-heptyl-11-aminoundecanoic acid,
the copolyamide 18/10,T, resulting from the polycondensation reaction of terephthalic acid, decanediamine and N-heptyl-11-aminoundecanoic acid,
the copolyamide 19/6,T, resulting from the polycondensation reaction of terephthalic acid, hexamethylenediamine and N-heptyl-12-aminododecanoic acid, and
the copolyamide 19/10,T, resulting from the polycondensation reaction of terephthalic acid, decanediamine and N-heptyl-12-aminododecanoic acid.

In the same way, mention could also be made of the copolyamides 23/6,T, 23/10,T, 24/6,T, 24/10,T, 29/6,T, 29/10,T, 30/6,T and 30/10,T.

According to a second version of the invention, the polycondensation reaction can also be carried out with the precursors (a), (b) and (c) in the presence of at least one of the other precursors below:
an aminocarboxylic acid and/or a lactam (d) different from (c),
a dicarboxylic acid (e) different from the terephthalic acid (a),
a diamine (f) different from the aliphatic diamine (b).

The precursor (d) may be an aminocarboxylic acid or a lactam, necessarily different from the aminocarboxylic acid or lactam (c).

Advantageously, the precursor (d) comprises a number of carbon atoms less than or equal to 12.

The aminocarboxylic acid (d) may, for example, be chosen from 9-aminononanoic acid (denoted by 9), 10-aminodecanoic acid (denoted by 10), 11-aminoundecanoic acid (denoted by 11) and 12-aminododecanoic acid (denoted by 12). Use will preferably be made of 11-aminoundecanoic acid, which has the advantage of being biobased since it comprises organic carbon resulting from biomass and determined according to the ASTM D6866 standard.

The lactam (d) may especially be chosen from the caprolactam (denoted by 6), decanolactam (denoted by 10), undecanolactam (denoted by 11) and lauryl lactam (denoted by 12). Use will preferably be made of lauryl lactam.

A copolyamide obtained from precursors (a), (b), (c) and (d) may thus comprise:
between 35 and 85 mol %, advantageously between 45 and 80 mol %, preferably between 50 and 75 mol % of terephthalic acid (a),
between 15 and 65 mol %, advantageously between 20 and 55 mol %, preferably between 25 and 50 mol % of aminocarboxylic acid and/or of lactam (c) and of aminocarboxylic acid and/or of lactam (d), and
between 35 and 85 mol %, advantageously between 45 and 80 mol %, preferably between 50 and 75 mol % of aliphatic diamine (b), the molar contents of precursors (a) and (b) being identical.

Among these copolyamides obtained from precursors (a), (b), (c) and (d), mention will very particularly be made of:
the copolyamide 11/18/6,T resulting from the polycondensation reaction of terephthalic acid, hexamethylenediamine, N-heptyl-11-aminoundecanoic acid and 11-aminoundecanoic acid or, optionally, undecanolactam,
the copolyamide 11/18/10,T resulting from the polycondensation reaction of terephthalic acid, decanediamine, N-heptyl-11-aminoundecanoic acid and 11-aminoundecanoic acid or, optionally, undecanolactam,
the copolyamide 12/18/6,T, resulting from the polycondensation reaction of terephthalic acid, hexamethylenediamine, N-heptyl-11-aminoundecanoic acid and lauryl lactam or, optionally, 12-aminododecanoic acid,
the copolyamide 12/18/10,T, resulting from the polycondensation reaction of terephthalic acid, decanediamine, N-heptyl-11-aminoundecanoic acid and lauryl lactam or, optionally, 12-aminododecanoic acid,
the copolyamide 11/23/6,T, resulting from the polycondensation reaction of terephthalic acid, hexamethylenediamine, N-dodecyl-11-aminoundecanoic acid and 11-aminoundecanoic acid or, optionally, undecanolactam,
the copolyamide 11/23/10,T resulting from the polycondensation reaction of terephthalic acid, decanediamine, N-dodecyl-11-aminoundecanoic acid and 11-aminoundecanoic acid or, optionally, undecanolactam,
the copolyamide 12/23/6,T, resulting from the polycondensation reaction of terephthalic acid, hexamethylenediamine, N-dodecyl-11-aminoundecanoic acid and lauryl lactam or, optionally, 12-aminododecanoic acid, and
the copolyamide 12/23/10,T, resulting from the polycondensation reaction of terephthalic acid, decanediamine, N-dodecyl-11-aminoundecanoic acid and lauryl lactam or, optionally, 12-aminododecanoic acid.

In the same way, mention could also be made of the copolyamides 11/19/6,T, 11/19/10,T, 12/19/6,T, 12/19/10,T, 11/24/6,T, 11/24/10,T, 12/24/6,T, 12/24/10,T, 11/29/6,T, 11/29/10,T, 12/29/6,T, 12/29/10,T, 11/30/6,T 11/30/10,T, 12/30/6,T and 12/30/10,T.

The precursor (e) is a dicarboxylic acid necessarily different from the terephthalic acid (a). This dicarboxylic acid (e) advantageously comprises between 4 and 36 carbon atoms.

The dicarboxylic acid (e) may be a linear or branched, aliphatic dicarboxylic acid, a cycloaliphatic dicarboxylic acid or else an aromatic dicarboxylic acid.

When the dicarboxylic acid (e) is aliphatic and linear, it may be chosen from succinic acid, pentanedioic acid, adipic acid, heptanedioic acid, octanedioic acid, azelaic acid, sebacic acid, undecanedioic acid, dodecanedioic acid, brassylic acid, tetradecanedioic acid, hexadecanedioic acid, octadecanedioic acid, octadecenedioic acid, eicosanedioic acid, docosanedioic acid and dimerized fatty acids containing 36 carbon atoms. Such dimerized fatty acids are especially available under the trade name Pripol®.

The aliphatic acids that have just been mentioned may comprise at least one alkyl branching to constitute the dicarboxylic acid (e), which then corresponds to an aliphatic and branched carboxylic acid. Such alkyl branching may be linear or branched, as was seen above for the alkyl branching of the aminocarboxylic acid and/or lactam (c). The aliphatic and branched carboxylic acid (e) may also comprise at least one linear alkyl branching and at least one branched alkyl branching.

When the dicarboxylic acid (e) is cycloaliphatic, it may comprise the carbon-based backbones such as cyclohexane, norbornylmethane, cyclohexylmethane, dicyclohexylmethane, dicyclohexylpropane and di(methylcyclohexyl)propane.

When the dicarboxylic acid (e) is aromatic, it is chosen from isophthalic acid (denoted by I) and naphthalenic diacids.

Preferably, linear or branched, aliphatic acids are chosen that make it possible to optimize the ductility of the final copolyamide.

A copolyamide obtained from precursors (a), (b), (c) and (e) may thus comprise:
between 35 and 85 mol %, advantageously between 45 and 80 mol %, preferably between 50 and 75 mol % of terephthalic acid (a),
between 15 and 65 mol %, advantageously between 20 and 55 mol %, preferably between 25 and 50 mol % of aminocarboxylic acid and/or of lactam (c) and of dicarboxylic acid (e),
the molar content of aliphatic diamine (b) being, itself, equal to the sum of the molar contents of terephthalic acid (a) and of dicarboxylic acid (e).

Preferably, when the dicarboxylic acid (e) is a dimerized fatty acid, the molar proportion of dicarboxylic acid (e) will not exceed 40% of all of the precursors (c) and (e) in order to limit the impact of the degree of purity of such a precursor on the properties of the final copolyamide.

In particular, this limitation of the molar proportion of dimerized fatty acids (e) to 40% of all of the precursors (c) and (e) makes it possible in particular to avoid the formation of the white spots observed during the synthesis of copolyamides from dimerized fatty acids as described in document US 2006/0235190. Such white spots, which correspond to heterogeneities having a very high melting point (around 360° C.) rich in the salt of terephthalic acid and of hexamethylenediamine express the poor compatibility between the dimerized fatty acids and the other precursors that are especially hexamethylenediamine and terephthalic acid.

Among these copolyamides obtained from precursors (a), (b), (c) and (e), mention may very particularly be made of the copolyamides 6,10/18/6,T, 6,12/18/6,T, 6,18/18/6,T, 6,36/18/6,T, 6,10/19/6,T, 6,12/19/6,T, 6,18/19/6,T, 6,36/19/6,T, 6,10/23/6,T, 6,12/23/6,T, 6,18/23/6,T, 6,36/23/6,T, 6,10/24/6,T, 6,12/24/6,T, 6,18/24/6,T, 6,36/24/6,T, 6,10/29/6,T, 6,12/29/6,T, 6,18/29/6,T, 6,36/29/6,T, 6,10/30/6,T, 6,12/30/6,T, 6,18/30/6,T, 6,36/30/6,T, 10,10/18/10,T, 10,12/18/10,T, 10,18/18/10,T, 10,36/18/10,T, 10,10/19/10,T, 10,12/19/10,T, 10,18/19/10,T, 10,36/19/10,T, 10,10/23/10,T, 10,12/23/10,T, 10,18/23/10,T, 10,36/23/10,T, 10,10/24/10,T, 10,12/24/10,T, 10,18/24/10,T, 10,36/24/10,T, 10,10/29/10,T, 10,12/29/10,T, 10,18/29/10,T, 10,36/30/10,T, 10,10/30/10,T, 10,12/30/10,T, 10,18/30/10,T and 10,36/30/10,T.

It is also possible to envisage a copolyamide obtained from all of the precursors (a), (b), (c), (d) and (e), in the following proportions:
between 35 and 85 mol %, advantageously between 45 and 80 mol %, preferably between 50 and 75 mol % of terephthalic acid (a),
between 15 and 65 mol %, advantageously between 20 and 55 mol %, preferably between 25 and 50 mol % of aminocarboxylic acid and/or of lactam (c), of aminocarboxylic acid and/or of lactam (d) and of dicarboxylic acid (e),
the molar content of aliphatic diamine (b) being equal to the sum of the molar contents of terephthalic acid (a) and of dicarboxylic acid (e).

Preferably, and for the reasons indicated above, when the dicarboxylic acid (e) is a dimerized fatty acid, the molar proportion of dicarboxylic acid (e) will not exceed 40% of all of the precursors (c), (d) and (e).

Among these copolyamides obtained from precursors (a), (b), (c), (d) and (e), mention may very particularly be made of the copolyamides 11/6,10/18/6,T, 11/6,12/18/6,T, 11/6,18/18/6,T, 11/6,36/18/6,T, 11/6,10/23/6,T, 11/6,12/23/6,T, 11/6,18/23/6,T, 11/6,36/23/6,T, 12/6,10/18/6,T, 12/6,12/18/6,T, 12/6,18/18/6,T, 12/6,36/18/6,T, 12/6,10/23/6,T, 12/6,12/23/6,T, 12/6,18/23/6,T, 12/6,36/23/6,T, 11/10,10/18/10,T, 11/10,12/18/10,T, 11/10,18/18/10,T, 11/10,36/18/10,T, 11/10,10/23/10,T, 11/10,12/23/10,T, 11/10,18/23/10,T, 11/10,36/23/10,T, 12/10,10/18/10,T, 12/10,12/18/10,T, 12/10,18/18/10,T, 12/10,36/18/10,T, 12/10,10/23/10,T, 12/10,12/23/10,T, 12/10,18/23/10,T and 12/10,36/23/10,T. The present list may of course be supplemented by the copolyamides in which the 18 unit resulting from N-heptyl-11-aminoundecanoic acid or the 23 unit resulting from N-dodecyl-11-aminoundecanoic acid, is replaced by one of the 19, 24, 29 and 30 units, respectively resulting from N-heptyl-12-aminododecanoic acid, N-dodecyl-12-amino-dodecanoic acid, N-octadecyl-11-aminoundecanoic acid and N-octadecyl-12-amino-dodecanoic acid.

The precursor (f) is a diamine necessarily different from the aliphatic diamine. This diamine (f) advantageously comprises between 4 and 36 carbon atoms.

The diamine (f) may be a linear or branched, aliphatic diamine, a cycloaliphatic diamine or else an alkylaromatic diamine.

When the diamine (f) is aliphatic and linear, it is advantageously chosen from butanediamine, pentanediamine, hexanediamine, heptanediamine, octanediamine, nonanediamine, decanediamine, undecanediamine, dodecanediamine, tridecane-diamine, tetradecanediamine, hexadecanediamine, octadecanediamine, octadecene-diamine, eicosanediamine, docosanediamine and diamines comprising 36 carbon atoms obtained from dimerized fatty acids. Such diamines obtained from dimerized fatty acids are especially available under the trade name Priamine®.

When the diamine (f) is aliphatic and branched, it may comprise one or more methyl or ethyl substituents on the main chain. For example, the diamine (f) may advantageously be chosen from 2,2,4-trimethyl-1,6-hexanediamine, 2,4,4-trimethyl-1,6-hexanediamine, 1,3-diaminopentane, 2-methyl-1,5-pentanediamine and 2-methyl-1,8-octanediamine.

When the diamine (f) is cycloaliphatic, it may be chosen from isophorone diamine, bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), p-bis(aminocyclohexyl)methane (PACM) and isopropylidenedi(cyclohexylamine) (PACP). This diamine (f) may also comprise carbon-based backbones such as those mentioned above for the dicarboxylic acid (e), when the latter is cycloaliphatic.

When the diamine (f) is alkylaromatic, it may be chosen from 1,3-xylylene-diamine and 1,4-xylylenediamine.

It is thus possible to envisage a copolyamide obtained from all of the precursors (a), (b), (c), (d), (e) and (f), in the following advantageous proportions:
between 35 and 85 mol %, advantageously between 45 and 80 mol %, preferably between 50 and 75 mol % of terephthalic acid (a),
between 15 and 65 mol %, advantageously between 20 and 55 mol %, preferably between 25 and 50 mol % of aminocarboxylic acid and/or of lactam (c), of aminocarboxylic acid and/or of lactam (d), of dicarboxylic acid (e) and of diamine (f),
the molar content of aliphatic diamine (b) being greater than or equal to the molar content of terephthalic acid (a) and the sum of the molar contents of aliphatic diamine (b) and of diamine (f) being equal to the sum of the molar contents of terephthalic acid (a) and of dicarboxylic acid (e).

Among these copolyamides obtained from precursors (a), (b), (c), (d), (e) and (f), mention may very particularly be made of the copolyamides 10,36/18/6,T, 12,36/18/6,T, 36,36/18/6,T, 10,36/23/6,T, 12,36/23/6,T, 36,36/23/6,T, 11/10,36/18/6,T, 11/12,36/18/6,T, 11/36,36/18/6,T, 11/10,36/23/6,T, 11/12,36/23/6,T, 11/36,36/23/6,T, 12/10,36/18/6,T, 12/12,36/18/6,T, 12/36,36/18/6,T, 12/10,36/23/6,T, 12/12,36/23/6,T, 12/36,36/23/6,T, 6,36/18/10,T, 12,36/18/10,T, 36,36/18/10,T, 6,36/23/10,T, 12,36/23/10,T, 36,36/23/10,T, 11/6,36/18/10,T, 11/12,36/18/10,T, 11/36,36/18/10,T, 11/6,36/23/10,T, 11/12,36/23/10,T, 11/36,36/23/10,T, 12/6,36/18/10,T, 12/12,36/18/10,T, 12/36,36/18/10,T, 12/6,36/23/10,T, 12/12,36/23/10,T and 12/36,36/23/10,T. As above, the present list may of course be supplemented by the copolyamides in which the 18 unit resulting from N-heptyl-11-aminoundecanoic acid or the 23 unit resulting from N-dodecyl-11-aminoundecanoic acid, is replaced by one of the 19, 24, 29 and 30 units, respectively resulting from N-heptyl-12-aminododecanoic acid, N-dodecyl-12-aminododecanoic acid, N-octadecyl-11-aminoundecanoic acid and N-octadecyl-12-aminododecanoic acid.

The present invention also relates to a process for preparing semiaromatic copolyamides as defined above.

This process comprises a step of polycondensation of the precursors already listed in the present description, namely:
terephthalic acid (a),
aliphatic diamine (b), and
an aminocarboxylic acid and/or a lactam (c) comprising a main chain and at least one linear or branched alkyl branching, the total number of carbon atoms of the aminocarboxylic acid and/or of the lactam (c) being between 12 and 36,

optionally,
an aminocarboxylic acid and/or a lactam (d) different from (c),
a dicarboxylic acid (e) different from the terephthalic acid (a),
a diamine (f) different from the aliphatic diamine (b).

Advantageously, the minimum number of carbon atoms of this amino-carboxylic acid and/or of this lactam (c) is strictly greater than 12.

The present invention finally relates to a composition comprising at least one semiaromatic copolyamide as defined above.

### EXAMPLES

Five semiaromatic copolyamides were prepared from the precursors (a), (b), (c) and (d) below:
terephthalic acid (a), denoted by T
hexanediamine (b), denoted by 6
N-heptyl-11-aminoundecanoic acid (c), denoted by 18
11-aminoundecanoic acid (d), denoted by 11.

The molar contents of each of the repeating units of these five copolyamides are given in Table 1 below.

The copolyamides 1 to 5 are synthesized by bulk polycondensation in a 1-litre autoclave. The precursors (a), (b), (c) and (d) are introduced into the reactor, in the molar contents indicated in Table 1, with 25% by weight of water, 0.25% by weight of acetic acid, 2000 ppm of sodium hypophosphite (catalyst) and 10 000 ppm of Irganox 1098 (antioxidant), the percentages by weight being given relative to the total weight of the precursors (a), (b), (c) and (d). The mixture is heated up to 262° C. with stirring and maintained at an autogenous pressure of 45 bar for 90 min. The pressure is then gradually lowered to atmospheric pressure while increasing the temperature of the mixture up to 310° C., over a period of 60 min. The polymerization is then continued under a nitrogen purge for an additional 60 min. The polymer is then drained through an outlet valve into water, then extruded in the form of a rod. This rod is then granulated.

TABLE 1

| Copolyamide | 11 | 18 | 6,T | T_{g} (° C.) | Tₘ (° C.) |
|---|---|---|---|---|---|
| Copolyamide 1 | 1 | 0 | 1.3 | 90 | 300 |
| Copolyamide 2 | 0.9 | 0.1 | 1.3 | 82 | 300 |
| Copolyamide 3 | 0.8 | 0.2 | 1.3 | 78 | 300 |
| Copolyamide 4 | 0.4 | 0.6 | 1.3 | 50 | 290 |
| Copolyamide 5 | 0 | 1 | 1.3 | 32 | 290 |

The copolyamides 2 to 5 are semiaromatic copolyamides within the meaning of the invention, whereas the copolyamide 1 is a semiaromatic copolyamide in accordance with the teaching of document EP 0 550 314.

The melting temperature and the glass transition temperature, denoted by T_{g}, were determined by differential scanning calorimetry (DSC) using a TA Instruments Q20 DSC following heating and cooling cycles from 20° C. to 350° C. at 20 ° C./min, the Tₘ and the T_{g} being measured over the 2^{nd} heat.

The T_{g} and Tₘ values obtained for each of the copolyamides 1 to 5 are reported in Table 1 above.

The measurement of the glass transition temperature of a polymer gives a first indication as to its stiffness.

Thus, it is observed that the more the content of unit 18 increases, the content of semiaromatic unit 6,T otherwise being identical, the more the T_{g} decreases and the less stiff the semiaromatic copolyamide is.

This result is all the more interesting since the Tₘ of the copolyamides 2 to 5 is only affected very slightly and remains in the vicinity of 300° C.

It is also important to note that, during the synthesis of the copolyamides 2 to 5, no formation of white spots in the reaction mixture was observed. Thus, it is quite possible to envisage the synthesis of a copolyamide 18/6,T endowed with great flexibility.

To refine these preliminary conclusions as regards the flexibility properties of the semiaromatic copolyamides according to the invention, tensile test specimens were produced (in accordance with the ISO 527 standard), injection-moulded on a microextruder, numbered 1, 2 and 3, respectively from copolyamides 1, 2 and 3 described in the Table 1 above.

Tensile tests were then carried out according to the ISO 527 standard in order to determine, for each series of test specimens 1 to 3, the values of:
modulus of elasticity or Young's modulus,
tensile strength, and
elongation at break.

These values are reported in Table 2 below:

TABLE 2

| | | Young's | Tensile | Elongation |
|---|---|---|---|---|
| | | modulus | strength | at break |
| Test specimens | Copolyamides | (MPa) | (MPa) | (%) |
| Test specimens 1 | Copolyamide 1 | 1285 | 48 | 6 |
| Test specimens 2 | Copolyamide 2 | 1185 | 65 | 20 |
| Test specimens 3 | Copolyamide 3 | 1135 | 72 | 11 |

Here too it is observed that the more the content of unit 18 increases in the copolyamide (the content of semiaromatic unit of course being constant),
the more the value of the Young's modulus decreases, and
the more the value of the tensile strength increases, clearly confirming that the semiaromatic copolyamide becomes more flexible.

It will also be noted that the elongation at break values of copolyamides 2 and 3 are clearly improved relative to those of copolyamide 1.

In order to verify that the toughness properties of the semiaromatic copolyamides according to the invention are comparable to those of the semiaromatic copolyamides known from the prior art, copolyamides 1 and 3 were injection-moulded to obtain bars, respectively numbered 1 and 3, in accordance with the ISO 179 standard. These bars 1 and 3 were then conditioned and kept for two weeks under 50% relative humidity.

Half of the bars 1 and 3 were notched, then tested by ISO 179-1eA Charpy pendulum impact with a pendulum of 7.5 Joules.

The other half of these unnotched bars 1 and 3 was then tested by ISO 179-1eU Charpy pendulum impact with a pendulum of 7.5 Joules.

In both cases, the energy absorbed by the bars 1 and 3, expressed in kJ/m², was measured at 23° C., and the corresponding values have been reported in Table 3 below.

TABLE 3

| | | Charpy unnotched | Charpy notched |
|---|---|---|---|
| Bars | Copolyamides | impact (kJ/m²) | impact (kJ/m²) |
| Bars 1 | Copolyamide 1 | 3 | 1 |
| Bars 3 | Copolyamide 3 | 7 | 3 |

It is observed that the toughness values of the bars 3 are quite comparable, or even slightly improved, relative to those of the bars 1 obtained from copolyamides such as those described in document EP 0 550 314.

By virtue of the copolyamides according to the invention, it is possible to choose very precisely the content of aminocarboxylic acid and/or of lactam (c) comprising a main chain and at least one linear or branched alkyl branching in order to obtain a semiaromatic copolyamide having a melting point greater than or equal to 200° C., comparable mechanical properties and improved flexibility properties relative to those of the copolyamides of the prior art, without limiting the industrial feasibility.

1. Copolyamide comprising the units resulting from the polycondensation reaction of the following precursors:
terephthalic acid (a),
an aliphatic diamine (b), which is preferably linear, comprising x carbon atoms, x being an integer between 6 and 22, and
an aminocarboxylic acid and/or a lactam (c) comprising a main chain and at least one linear or branched alkyl branching, the total number of carbon atoms of the aminocarboxylic acid and/or of the lactam (c) being between 12 and 36, optionally,
an aminocarboxylic acid and/or a lactam (d) different from (c),
a dicarboxylic acid (e) different from the terephthalic acid (a),
a diamine (f) different from the aliphatic diamine (b).

2. Copolyamide according to claim 1, characterized in that the aminocarboxylic acid and/or the lactam (c) comprises a total number of carbon atoms between 15 and 30, preferably between 18 and 24.

3. Copolyamide according to claim 1, characterized in that the main chain of the aminocarboxylic acid and/or of the lactam (c) comprises between 6 and 18 carbon atoms, preferably between 10 and 12 carbon atoms.

4. Copolyamide according to claim 1, characterized in that the alkyl branching of the aminocarboxylic acid and/or of the lactam (c) comprises at least 5 carbon atoms, advantageously at least 7 carbon atoms.

5. Copolyamide according to claim 1, characterized in that the aminocarboxylic acid (c) is chosen from N-heptyl-11-aminoundecanoic acid (18), N-heptyl-12-aminododecanoic acid (19), N-dodecyl-11-aminoundecanoic acid (23), N-dodecyl-12-aminododecanoic acid (24), N-octadecyl-11-aminoundecanoic acid (29) and N-octadecyl-12-aminododecanoic acid (30).

6. Copolyamide according to claim 1, characterized in that the aliphatic diamine (b) comprises between 6 and 18 carbon atoms and is, preferably, hexanediamine or decanediamine.

7. Copolyamide according to claim 1, characterized in that the aminocarboxylic acid and/or the lactam (d) comprises a number of carbon atoms less than or equal to 12.

8. Copolyamide according to claim 7, characterized in that the aminocarboxylic acid (d) is chosen from 9-aminononanoic acid, 10-aminodecanoic acid, 11-aminoundecanoic acid and 12-aminododecanoic acid, preferably 11-aminoundecanoic acid.

9. Copolyamide according to claim 7, characterized in that the lactam (d) is chosen from caprolactam, decanolactam, undecanolactam and lauryl lactam, preferably lauryl lactam.

10. Copolyamide according to claim 1, characterized in that it comprises:
between 35 and 85 mol % of terephthalic acid (a) and of aliphatic diamine (b), and
between 15 and 65 mol % of aminocarboxylic acid and/or of lactam (c).

11. Copolyamide according to claim 1, characterized in that it comprises:
between 35 and 85 mol % of terephthalic acid (a) and of aliphatic diamine (b), and
between 15 and 65 mol % of aminocarboxylic acid and/or of lactam (c) and of amino-carboxylic acid and/or of lactam (d).

12. Copolyamide according to claim 1, characterized in that it comprises:
between 35 and 85 mol % of terephthalic acid (a),
between 15 and 65 mol % of aminocarboxylic acid and/or of lactam (c) and of dicarboxylic acid (e),
the molar content of aliphatic diamine (b) being equal to the sum of the molar contents of terephthalic acid (a) and of dicarboxylic acid (e).

13. Copolyamide according to claim 1, characterized in that it comprises:
between 35 and 85 mol % of terephthalic acid (a),
between 15 and 65 mol % of aminocarboxylic acid and/or of lactam (c), of aminocarboxylic acid and/or of lactam (d) and of dicarboxylic acid (e),
the molar content of aliphatic diamine (b) being equal to the sum of the molar contents of terephthalic acid (a) and of dicarboxylic acid (e).

14. Copolyamide according to claim 1, characterized in that it comprises:
between 35 and 85 mol % of terephthalic acid (a),
between 15 and 65 mol % of aminocarboxylic acid and/or of lactam (c), of aminocarboxylic acid or of lactam (d), of dicarboxylic acid (e) and of diamine (f),
the molar content of aliphatic diamine (b) being greater than or equal to the molar content of terephthalic acid (a) and the sum of the molar contents of aliphatic diamine (b) and of diamine (f) being equal to the sum of the molar contents of terephthalic acid (a) and of dicarboxylic acid (e).

15. Copolyamide according to claim 1, characterized in that it corresponds to the formula: 18/6,T, 18/10,T, 11/18/6,T, 11/18/10,T, 11/19/10,T, 12/19/10,T, 12/18/6,T, 12/18/10,T, 11/23/6,T, 11/23/10,T, 12/23/6,T, 12/23/10,T, 11/24/6,T, 11/24/10,T, 12/24/6,T, 12/24/10,T, 11/29/6,T, 11/29/10,T, 12/29/6,T, 12/29/10,T, 11/30/6,T, 11/30/10,T, 12/30/6,T or 12/30/10,T.

16. Process for preparing the copolyamide as defined in claim 1, characterized in that it comprises a step of polycondensation of the precursors (a), (b), (c) and, optionally, (d), (e) and (f).

17. Composition comprising at least one copolyamide as defined in claim 1.
